(19) United States
(12) Patent Application Publication
(10) Pub. No.: US 2010/0281357 A1
(43) Pub. Date: Nov. 4, 2010

(54) SYSTEM AND METHOD FOR PROCESSING A WIDGET AT A WEB BROWSER

(75) Inventors: Rong Yao Fu, Beijing (CN); Wei Gao, Beijjing (CN); Yin Qin Yu, Beijing (CN); Xue Song Zhang, Beijing (CN); Shi Wan Zhao, Beijing (CN)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/769,759

(22) Filed: Apr. 29, 2010

(30) Foreign Application Priority Data
Apr. 30, 2009 (CN) 200910136954.4

(51) Int. Cl. G06F 9/46; G06F 17/00

(52) U.S. Cl. 715/234; 719/318

(57) ABSTRACT

A system and method for processing a Widget at a Web browser. The system includes: a code analyzer for analyzing codes of a Widget to generate an event-instruction mapping table; an event dispatcher which, in response to monitoring of an event of the Widget, queries the event-instruction mapping table to determine whether a corresponding instruction needs to be executed; and a code parser which executes or invokes other means to execute the corresponding instruction, in response to that the event dispatcher determines the corresponding instruction needs to be executed. It is possible to correctly render a Widget at a client without the need to perform more work by a corresponding server.

### FIELD OF THE INVENTION

### Cross Reference to Related Application

This application claims priority under 35 U.S.C. 119 from Chinese Patent Application 200910136954.4, filed Apr. 30, 2009, the entire contents of which are incorporated herein by reference.

### BACKGROUND OF THE INVENTION

1. Field of the Invention

The present invention relates to information technology and more particularly, to a system and method for processing a Widget at a Web browser.

2. Description of Related Art

A Widget is a small application, which may be a clock, a diary, a fragment of video, weather forecast, a Flash game, etc. The Widget may be embedded into Web pages.

FIG. 1 illustrates a Web page, http://finance.yahoo.com. As shown in block 110, there is an input box and a button (GET QUOTES) in this Web page. When a user enters a company name (e.g., IBM) into this input box and then clicks on the button GET QUOTES, the page will change to display information on this company's share, as shown in block 120 of FIG. 2.

In order to provide the above-described function, developers need to implement many modules including a database query module, a program logic module, a user interface module, and so on. Developers may also develop a Web Widget with the same function, through simple encapsulation with the employment of content provided in the exemplary Web page http://finance.yahoo.com. When the Web Widget is run, rendered are only an input box and a button (GET QUOTES), as shown in block 110. After a user enters a company name into the input block and then clicks on the button GET QUOTES, only information on the company's share as shown in block 120 is rendered together with the input box and the button as shown in block 110. Other information is not rendered.

In the prior art, main processing work is performed at the server in order to render at the client the Web Widget developed by simply encapsulating an existing Web application. In this solution, the server initiates a browser simulator for each client that accesses the Web Widget, for interacting with http://finance.yahoo.com, and performs further processing (e.g., clipping) to the Web page that has been processed by the browser simulator so as to return the desired portion to the client.

A disadvantage in this solution is that when many clients access the Web Widget, the server is placed under great pressure and requires a lot of resources to satisfy accesses from clients.

Therefore, there is a need to render at a client, e.g., at a browser, a Web Widget developed by simply encapsulating an existing Web application, in a manner different from the prior art.

### SUMMARY OF THE INVENTION

An object of the present invention is to provide a solution where a Widget can be correctly rendered at a client without the need to perform more work by a corresponding server.

In accordance with one aspect of the present invention, a system for processing a Widget at a Web browser includes: a code analyzer for analyzing codes of a Widget to generate an event-instruction mapping table; an event dispatcher which, in response to detection of an event of the Widget, queries the event-instruction mapping table to determine whether a corresponding instruction needs to be executed; and a code parser which causes execution of a corresponding instruction, in response to a determination by the event dispatcher that the corresponding instruction needs to be executed.

In accordance with another aspect of the present invention, a computer implemented method for processing a Widget at a Web browser includes the steps of: analyzing codes of a Widget to generate an event-instruction mapping table; in response to detection of an event of the Widget, querying the event-instruction mapping table to determine whether a corresponding instruction needs to be executed; and executing the corresponding instruction in response to a determination that the corresponding instruction needs to be executed.

With the present invention, it is possible to correctly render a Widget at a client without the need to perform more work by a corresponding server.

### BRIEF DESCRIPTION OF THE DRAWINGS

As the present invention is better understood, other objects and effects of the present invention will become more apparent and easy to understand from the following description, taken in conjunction with the accompanying drawings wherein:

FIG. 1 shows an exemplary Web page;

FIG. 2 shows another Web page that is rendered after performing operation to the Web page in FIG. 1;

FIG. 3 shows a system in which the present invention may be implemented;

FIGS. 4A and 4B schematically show a block diagram of a Widget browser plug-in according to an embodiment of the present invention;

FIGS. 5A and 5B schematically show a flowchart of a method of processing a Widget according to an embodiment of the present invention; and

FIGS. 6A-6C schematically show corresponding circumstances that occur during rendering according to an embodiment of the present invention.

Like reference numerals designate the same, similar, or corresponding features or functions throughout the drawings.

### DETAILED DESCRIPTION OF THE PREFERRED EMBODIMENTS

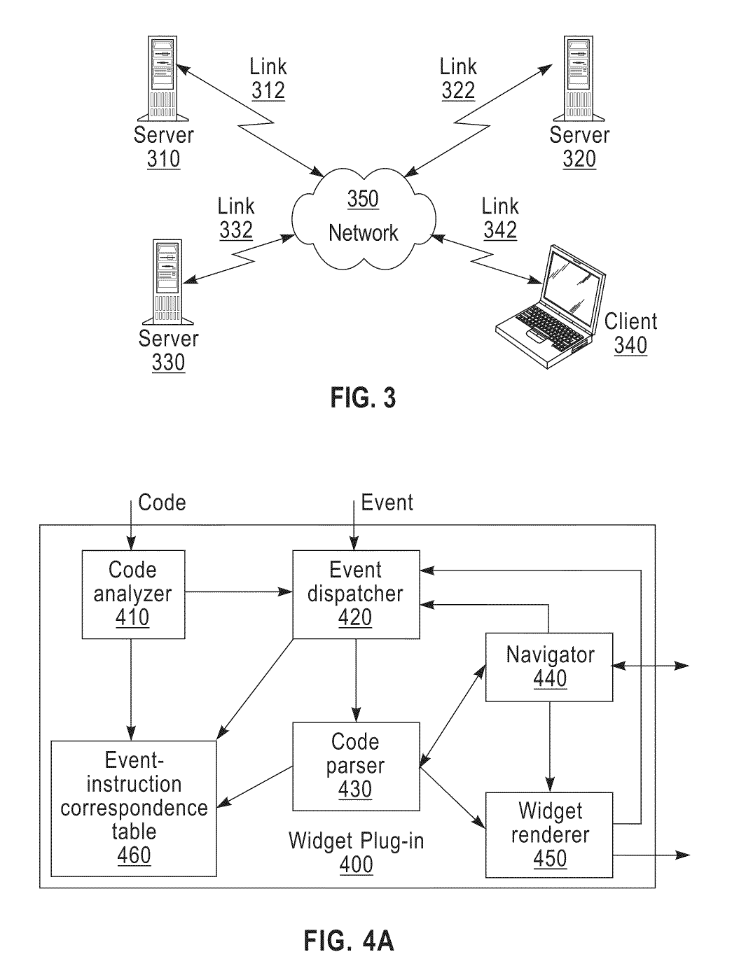

FIG. 3 illustrates a system 300 in which the present invention may be implemented. As illustrated in FIG. 3, system 300 includes a server 310, a server 320, a server 330, a client 340, and a network 350. Each of servers 310, 320, 330 and client 340 may be a laptop, a minicomputer, a midrange, or a mainframe. Server 310 is connected to network 350 via a link 312, server 320 is connected to network 350 via a link 322, server 330 is connected to network 350 via a link 332, and client 340 is connected to network 350 via a link 342. Each of links 312, 322, 332, and 342 may be a wired link such as a coaxial cable, an optical fiber and so on, or a wireless link such as a satellite link and the like. Likewise, network 350 may be a wireless network, a wired network, or a combination thereof. Further, network 350 may be a local area network, a metropolitan area network, a wide area network, or a combination thereof. For example, network 350 is the Internet.

Of course, those skilled in the art will appreciate that other client(s) and/or server(s) may be connected on network 350. In order to be differentiated from each other, each of the client and the servers may have an identification capable of uniquely identifying it, such as an IP address, a Uniform Resource Locator (URL) and so on.

In this embodiment of the present invention, run on server 310 is a Web application into which a Web Widget is embedded. Concrete codes (e.g., Extensible Markup Language scripts) of the Web Widget are placed on server 320, and the Web Widget is obtained by encapsulating a Web application on server 330. A system for processing a Widget at a Web browser according to the present invention is installed at client 340. Of course, those skilled in the art would appreciate that concrete codes of the Web Widget may be placed on server 310 directly.

For example, supposing a scenario in which a Web page myhomepage.html containing a Web Widget (e.g., a Widget via which information on shares can be queried) is run on server 310, a Widget tag is thus added to the page myhomepage.html.

In the prior art, server 320 or 310 is in charge of main work of rendering at client 340 the Web Widget developed by simply encapsulating an existing Web application.

According to the embodiment of the present invention, a system for processing a Widget at a Web browser is however responsible for rendering at client 340 the Web Widget developed by simply encapsulating an existing Web application, which system may be, for example, a Widget browser plug-in.

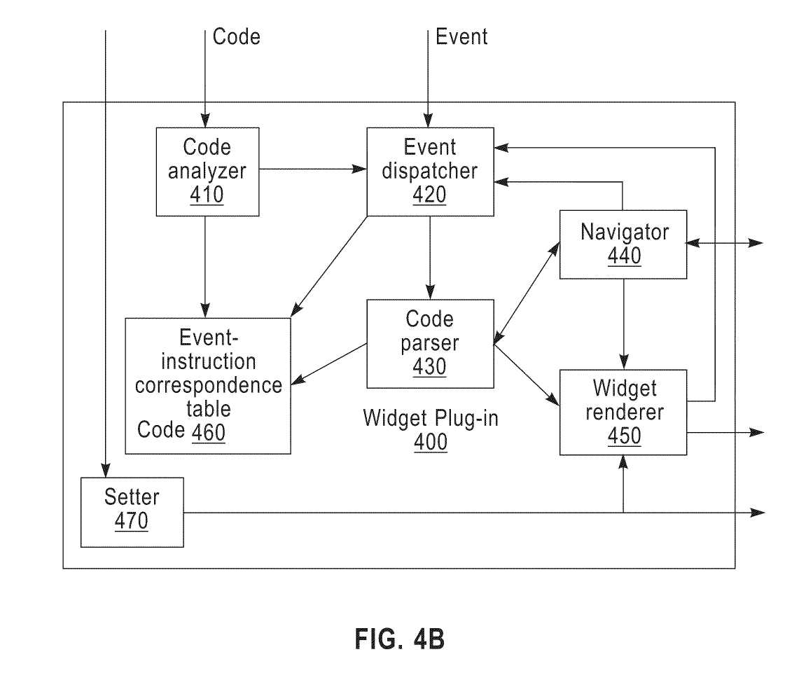

FIG. 4A schematically shows a block diagram of a Widget browser plug-in according to an embodiment of the present invention. The Web browser (hereinafter referred to as “browser”) may be, for example, a Foxfire browser, an Internet Explorer browser, and so on.

As shown in FIG. 4A, Widget browser plug-in 400 includes a code analyzer 410, an event dispatcher 420, a code parser 430, a navigator 440, and a Widget renderer 450.

A detailed description is given below to functions of the respective means of Widget browser plug-in 400 and relationships among the respective means.

When a browser (e.g., a browser of client 340 in FIG. 3) is loaded with, for example, myhomepage.html from server 310, the browser detects a Widget tag in the Web page's HTML codes. For example, the Web page's HTML codes include:

<Widget script-URL=’...’>
</Widget>

Then, the browser invokes Widget browser plug-in 400.

Widget browser plug-in 400 is responsible for processing all Widget tags, just as a flash browser plug-in may process a plurality of flash within one page.

Afterwards, Widget browser plug-in 400 retrieves Widget codes corresponding to the Widget from a corresponding server (here from server 320), according to the URL included in the Widget tag.

Of course, the browser may retrieve the Widget codes from a corresponding server and provides the retrieved codes to Widget browser plug-in 400 when Widget browser plug-in 400 is being activated.

Code analyzer 410 analyzes the retrieved Widget codes to generate an event-instruction mapping table 460. Event-instruction mapping table 460 records a corresponding instruction that is to be executed by Widget browser plug-in 400, when a specific event of the Widget takes place.

For example, the analysis of Widget codes of “Sample Widget” results in an exemplary event-instruction mapping table 460 as shown in Table 1 in which content in the left-hand column represents events and content in the right-hand column represents corresponding instructions. “Sample Widget” is encapsulated from a page http://www.example.com, which is like the Widget encapsulated from http://finance.yahoo.com as described in the Background of the Invention. After a user enters corresponding content into an input box of “Sample. Widget” and clicks on a search button, information associated with the input content will be rendered, but other information in the page http://www.example.com will not be rendered. Developers may develop such Widget by utilizing various tools.

It should be noted that those skilled in the art may implement code analyzer 410 in various fashions, and details of the code analyzer 410 are not given here for the purpose of simplicity.

TABLE 1
Name = Sample Widget
entry = http://www.example.com

| | |
|---|---|
| event=start | Load http://www.example.com |
| event=load location= | render xpath://form[id= ‘search’ ] |
| http:// www.example.com | fill form ‘search’ by {keyWord : |
| | ‘test’ } |
| event=load location=pattern(′/ | render xpath://form[id= ‘search’ ] |
| www.example.com/detail/*′) | render xpath://table[id= ‘detail ‘] |

Upon completion of the analysis, code analyzer 410 triggers a start event.

Event dispatcher 420 monitors respective events of the Widget. In response to monitoring of an event of the Widget, event dispatcher 420 queries the event-instruction mapping table to determine whether there is a need to execute a corresponding instruction.

For example, if event dispatcher 420 monitors a start event and determines that there is a need to execute a corresponding instruction, by querying Table 1, code parser 430 is then invoked. Code parser 430 analyzes the instruction and executes or invokes corresponding means to execute the instruction.

For example, according to Table 1, instruction corresponding to the start event is load instruction “Load http://www.example.com,” i.e., to load the entry page http://www.example.com from which “Sample Widget” is encapsulated. Then, code parser 430 executes the load instruction, i.e., loads the entry page.

According to an embodiment of the present invention, code parser 430 loads the entry page by, for example, invoking navigator 440.

Upon completion of loading of the entry page, a load event is triggered.

In response to monitoring of this event, event dispatcher 420 queries the event-instruction mapping table to determine whether there is another instruction to be executed.

If event dispatcher 420 determines that there is another to-be-executed instruction matching the load event (in terms of event type and URL), by querying the event-instruction mapping table, code parser 430 is invoked. Code parser 430 analyzes the instruction and executes or invokes corresponding means to execute the instruction.

According to Table 1, instructions to be executed and corresponding to the event load location=http://www.example.com (load event) are render xpath://form[id=‘search’] and fill form ‘search’ by {keyword: ‘test’}, which mean rendering for a returned page, rendering the Web page node specified in xpath—a search form here, and automatically filling the form (fill specified field with specified value). Hence, code parser 430 invokes renderer 450 to render the search form portion in the returned page and fill the specified field (search) with the specified value “test.”

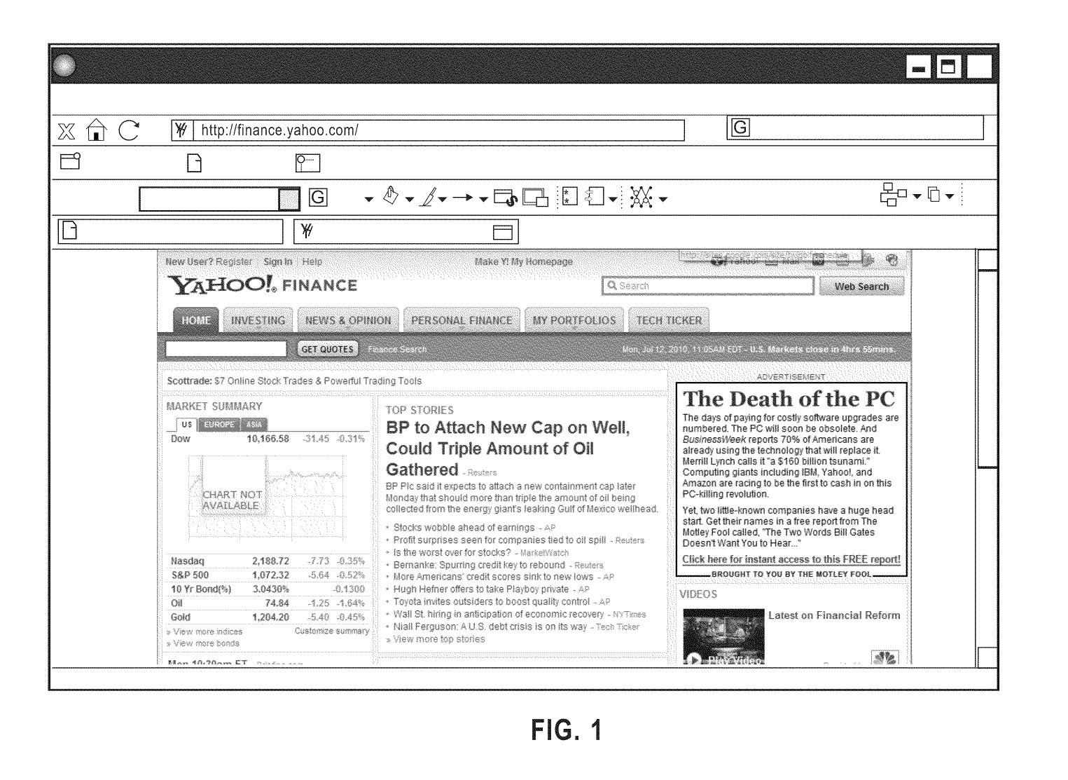

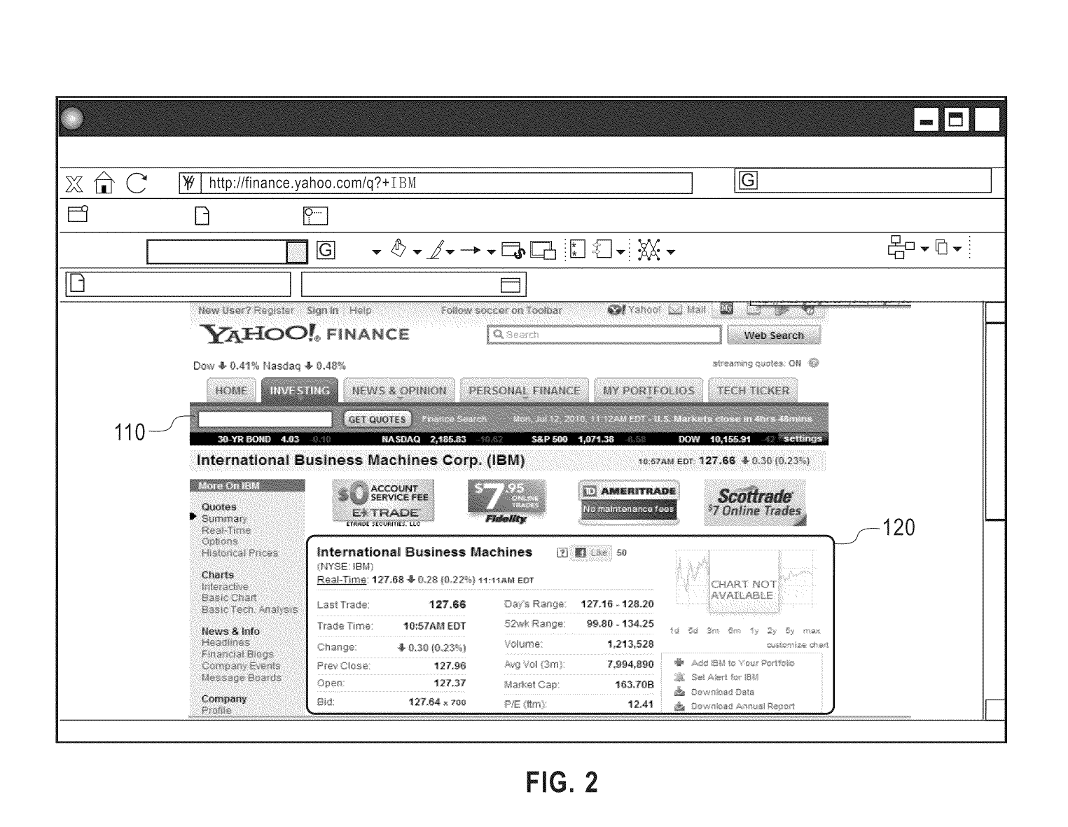

After the above processing, block 110 as shown in FIG. 1 is displayed on the browser, in which the input box is filled with “test”.

In an embodiment of the present invention, an Iframe-Div structure is utilized when a Widget is being rendered. That is, after the Web browser encounters a Widget tag in a page and invokes the Widget browser plug-in, the Widget browser plug-in will generate a Div tag and embed into the Div tag an Iframe tag for replacing the Widget tag. The Iframe tag carries detailed content of the Widget. In other words, the inner layer is the Iframe tag carrying detailed content of the Widget, and the outer layer is the Div tag deciding an area available for display.

As shown in FIG. 4B, in this embodiment, the Widget browser plug-in further includes a setter 470 for generating a Div tag and embedding into the Div tag an Iframe tag for replacing the Widget tag, wherein the Iframe tag carries detailed content of the Widget.

Iframe tag is also called a floating frame tag, which may be used to embed an HTML document into an area of an HTML page to display.

The Iframe tag is used in the following format:

<Iframe src=“http://xxx.xxx.xxx” width=“x” height=“x”
scrolling=“[OPTION]” frameborder=“x”></Iframe>

src: representing the path of a document to be rendered, which document may be either an HTML document or text, ASP, and so on.

width and height: the width and height of an area.

scrolling: when an HTML document specified by src cannot be completely rendered in a specified area, if a scrolling option is set to NO, then a scrolling bar does not appear; if a scrolling option is set to Auto, then the scrolling bar appears automatically; if a scrolling option is set to Yes, then the scrolling bar appears.

Frameborder: the width of an area frameborder.

Of course, those skilled in the art would appreciate that some of the above parameters are not necessary at the same time.

A Div tag is a tag for providing a structure and background to the block content of an HTML document.

A Div tag is set according to the Widget's corresponding settings in www.myhomepage.html.

An example of embedding an Iframe tag into a Div tag is shown as below:

```
<div id=“inner.div.yahoo.Widget” style=“overflow: hidden;
display: block; position: relative; width: 100%; height: 860px;”>
  <iframe id=“yahoo.Widget” width=“1024px” scrolling=“no”
height=“2500 px” frameborder=“no” src=http://finance.yahoo.com/ ... >
  . . .
  </iframe>
</div>
```

The Div tag is named inner.div.yahoo.Widget, which defines an area whose width is the entire width of the browser and whose height is 860 pixels (relative value).

An Iframe tag is embedded into this Div tag. The Iframe tag is named yahoo.Widget, whose area has a width of 1024 pixels and a height of 2500 pixels.

Since the meaning of the above codes would be apparent to those skilled in the art, a detailed description is omitted here for the purpose of simplicity.

The so-called completion of loading means that the entry page has been loaded and placed in Iframe, i.e., src of the Iframe tag has been modified to http://www.example.com. When a new page begins to be loaded, the Widget browser plug-in, or more particularly, setter 470, sets the Div tag to be hidden in order to prevent content, which does not need to be displayed, from being exposed to the user. For example, the outer layer is a Div tag style=“overflow: hidden; width: 437 px; height: 47 px;”.

The first step of rendering is to locate in a Widget entry page the following content, which needs to be displayed: DOM (Document Object Model) node (one or more nodes; in the case of more nodes, there is a parent node and its child nodes; in this embodiment of the present invention, supposing there is only one node), and to obtain the corresponding information for the DOM node, including coordinate (start point) and size (width and height along the start point), i.e., corresponding content concerning a place for display.

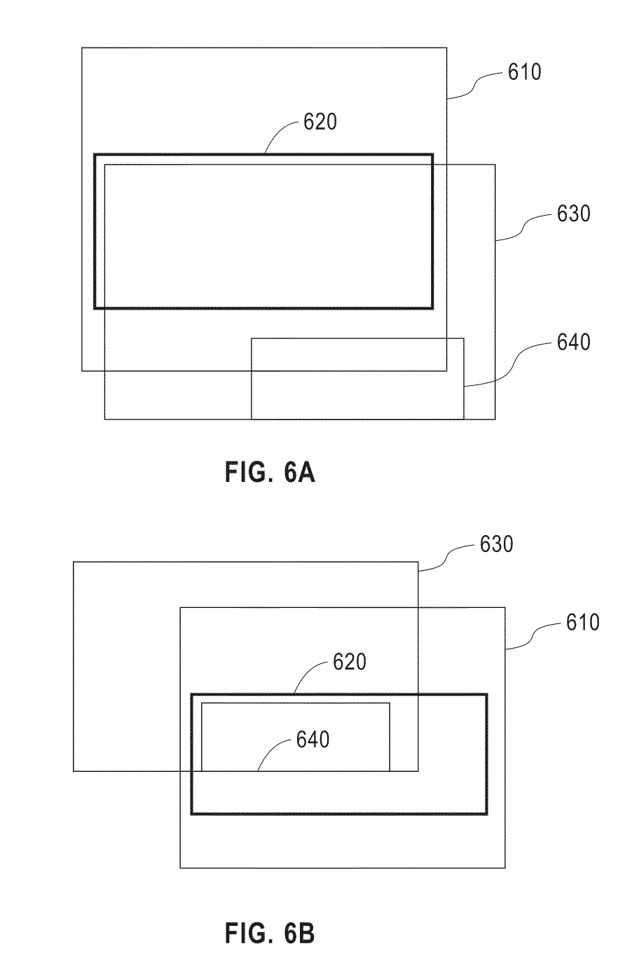

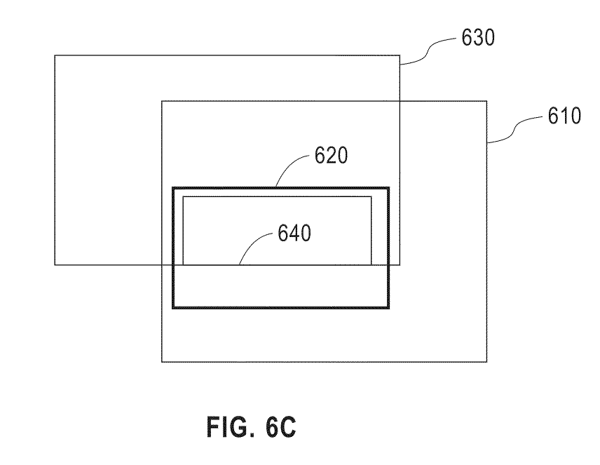

The inner layer is an Iframe tag which carries the Widget entry page http://www.example.com, and the entry page might be huge enough to exceed a rendering area set by a Div tag. For example, as shown in FIG. 6A, a block 610 represents a rendering area of a Web page www.myhomepage.html where the Widget is located, a block 620 represents the rendering area set by the Div tag, a block 630 represents a rendering area required by the entry page to http://www.example.com (e.g., the entire page in FIG. 1), and a block 640 represents real content which needs to be rendered (e.g., 110 in FIG. 1). However, the content cannot be rendered because it is located outside rendering area 620 set by the Div tag.

The second step of rendering is hence to adjust the absolute position of the Iframe tag by employing cascading style sheet CSS, such that content 640 that needs to be rendered appears inside rendering area 620 set by the Div tag.

For example, as shown in FIG. 6B, block 640 appears inside block 620 by adjusting the absolute position (style=“left: −4 px; top: −262 px; position: absolute;”) of the Iframe tag.

Next, the third step is to adjust the CSS of Div tag such that rendering area 620 set by the Div tag conforms to the size of content 640 that needs to be rendered.

As shown in FIG. 6C, the size of block 620 is adapted to the size of block 640 by adjusting the CSS of the Div tag, such that block 620 just includes block 640.

Finally, the fourth step is to set the style attribute of the Div tag at the outer layer to be visible, so that the user can see content in the rendering area set by the Div tag.

The event recorded on the third line of Table 1 is that loading of a specified Web page is completed (the Web page conforms to a given pattern, i.e., URL matches), and corresponding instruction to be executed is to render (by renderer 450) the returned Web page, wherein only the Web page node portion specified in xpath is rendered.

After execution of the instruction recorded on the third line of Table 1, block 110 and block 120, for example, are displayed on the browser.

If event dispatcher 420 monitors an event of the Widget, whereas this event has not been registered for management, i.e., the event-instruction mapping table does not contain to-be-executed instruction that corresponds to the event, then Widget plug-in 400 takes no action, but the browser takes corresponding action with respect to this event.

Of course, those skilled in the art would appreciate that the present invention also applies to circumstance in which an entire Web page other than a specified node portion of the Web page needs to be rendered.

Those skilled in the art would also appreciate that the event-instruction mapping table is merely exemplary, and that more events may be registered for management in reality, i.e., the event-instruction mapping table contains more event-instruction entries.

Those skilled in the art would further appreciate that rendering may be implemented using other techniques. The present invention is not focused on techniques that are used for rendering Widgets, but on the ability to correctly render a Widget at a client without the need for a corresponding server to perform more work.

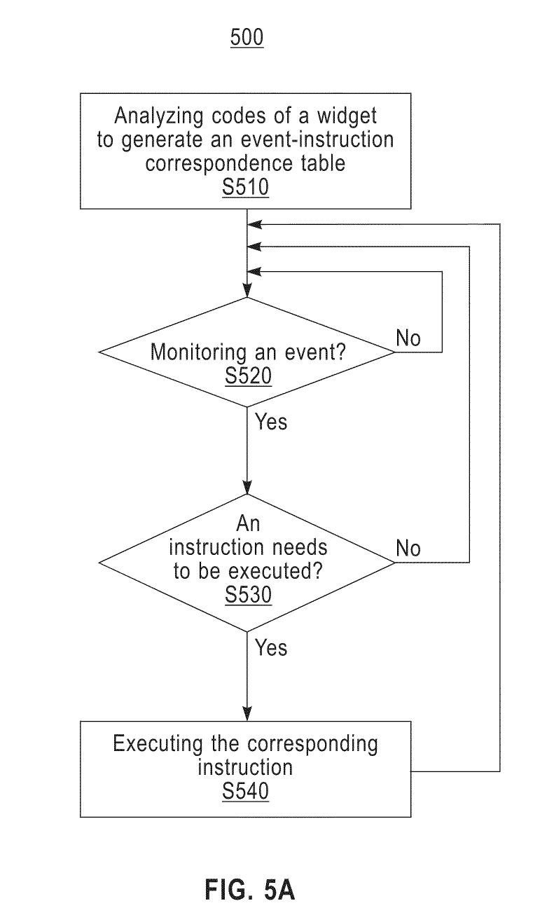

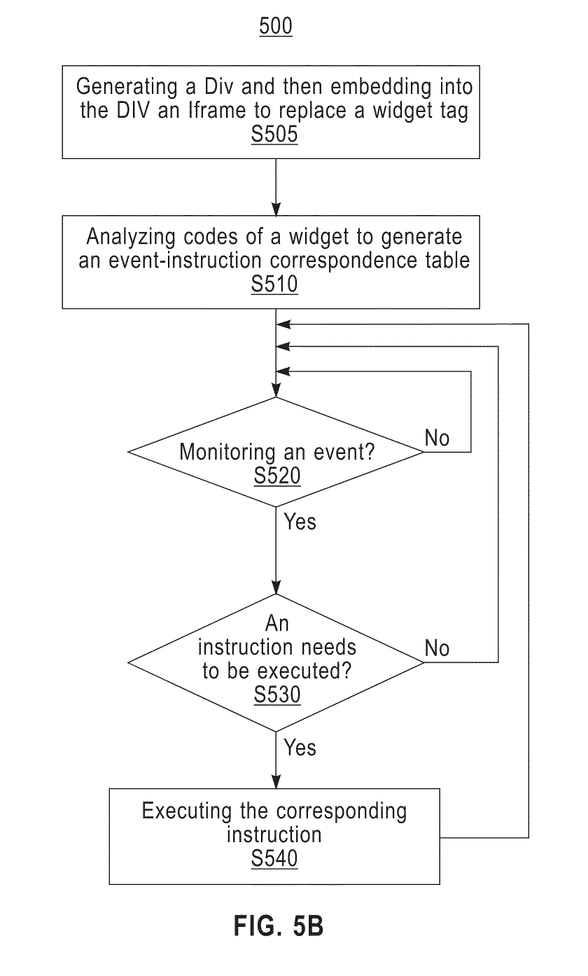

FIG. 5A schematically shows a flowchart of a method for processing a Widget at a Web browser according to an embodiment of the present invention.

As shown in FIG. 5A, the method 500 starts with analyzing (step S510) codes of a Widget to generate an event-instruction mapping table.

Then, judgment is made as to whether an event of the Widget is monitored (step S520). In response to monitoring of an event of the Widget (branch “Yes” of step S520), the event-instruction mapping table is queried (step S530) to determine whether a corresponding instruction needs to be executed.

In response to that a corresponding instruction needs to be executed (branch “Yes” of step S530), the corresponding instruction is executed (step S540). After completion of the execution of the corresponding instruction, the flow returns to step S520.

In response to that corresponding instruction does not need to be executed (branch “No” of step S530), by querying the event-instruction mapping table, the flow returns to step S520.

The instruction that needs to be executed includes loading a page.

The instruction that needs to be executed includes rendering a page or a specified node portion of a page, for example, rendering portion 110 in FIG. 1.

In an embodiment of the present invention, an Iframe-Div structure is utilized when a Widget is being rendered. That is, after the Web browser encounters a Widget tag in a page and invokes the Widget browser plug-in, the Widget browser plug-in will generate a Div tag and embed into the Div tag an Iframe tag for replacing the Widget tag. The Iframe tag carries detailed content of the Widget. In other words, the inner layer is the Iframe tag carrying detailed content of the Widget, and the outer layer is the Div tag deciding an area available for display.

In other words, this embodiment, prior to step S510 further includes step S505 in which a Div tag is generated and an Iframe tag is embedded into the Div tag to replace the Widget tag. The Iframe tag carries detailed content of the Widget.

Furthermore, rendering includes: a first step to locate in a Widget entry page the following content, which needs to be displayed: DOM (Document Object Model) node and to obtain the corresponding information for the DOM node, including coordinate and size; a second step in which the absolute position of the Iframe tag is adjusted by using cascading style sheet CSS, such that content that needs to be rendered appears inside a rendering area set by the Div tag; a third step in which the CSS of the Div tag is adjusted such that the rendering area set by the Div tag conforms to the size of content that needs to be rendered; and a fourth step in which the style attribute of the Div tag which was set to be hidden during loading the new page is set to be visible, so that the user can see content in the rendering area set by the Div tag.

It should be noted that in order to make the present invention easier to be understood, the foregoing description omits some technical details that are well known to those skilled in the art but might be essential to the implementation of the present invention.

The specification of the present invention has been presented for purposes of illustration and description, and is not intended to be exhaustive or limited to the invention in the form disclosed. Many modifications and alterations will be apparent to those of ordinary skill in the art.

Therefore, the embodiments were chosen and described in order to better explain the principles of the present invention, the practical application, and to enable others of ordinary skill in the art to understand that all modifications and alterations made without departing from the spirit of the present invention fall into the protection scope of the present invention as defined in the appended claims.

What is claimed is:

1. A system for processing a Widget at a Web browser, comprising:
a code analyzer for analyzing codes of a Widget to generate an event-instruction mapping table;
an event dispatcher which, in response to detection of an event of the Widget, queries the event-instruction mapping table to determine whether a corresponding instruction needs to be executed; and
a code parser which causes execution of a corresponding instruction, in response to a determination by the event dispatcher that the corresponding instruction needs to be executed.

2. The system corresponding to claim 1, further comprising:
a navigator which, in response to a determination that the corresponding instruction is to load a page, is invoked by the code parser to load the page.

3. The system corresponding to claim 1, further comprising:
a Widget renderer which, in response to a determination that the corresponding instruction is to render a page or a specified node portion of a page, is invoked by the code parser to render the page or the specified node portion of the page.

4. The system corresponding to claim 3, further comprising:
a setter for generating a Div tag and then embedding into the Div tag an Iframe tag to replace the Widget tag, wherein the Iframe tag carries detailed content of the Widget.

5. A computer implemented method for processing a Widget at a Web browser, comprising the steps of:
analyzing codes of a Widget to generate an event-instruction mapping table;
in response to detection of an event of the Widget, querying the event-instruction mapping table to determine whether a corresponding instruction needs to be executed; and
executing the corresponding instruction in response to a determination that the corresponding instruction needs to be executed.

6. The method according to claim 5, wherein the corresponding instruction includes an instruction to load a page

7. The method according to claim 5, wherein the corresponding instruction comprises rendering a page or a specified node portion of a page.

8. The method according to claim 7, further comprising
generating a Div tag and then embedding into the Div tag an Iframe tag to replace the Widget tag, wherein the Iframe tag carries detailed content of the Widget.
